(19) United States
(12) Patent Application Publication
(10) Pub. No.: US 2007/0279350 A1
(43) Pub. Date: Dec. 6, 2007

(54) METHOD AND APPARATUS FOR DRIVING BISTABLE LIQUID CRYSTAL DISPLAY

(75) Inventors: Xiao-Yang Huang, Stow, OH (US); Duane Marhefka, Copley, OH (US); Todd Ernst, Tallmadge, OH (US)

Correspondence Address: PEARNE & GORDON LLP, 1801 EAST 9TH STREET, SUITE 1200, CLEVELAND, OH, 44114-3108, US

(73) Assignee: KENT DISPLAYS INCORPORATED, Kent, OH (US)

(21) Appl. No.: 11/626,428

(22) Filed: Jan. 24, 2007

Related U.S. Application Data
(60) Provisional application No. 60/803,778, filed on Jun. 2, 2006.
(60) Provisional application No. 60/822,128, filed on Aug. 11, 2006.

(51) Int. Cl. G09G 3/36

(52) U.S. Cl. 345/87

(57) ABSTRACT

An apparatus and method of using a driver (e.g., a commercially available, off-the-shelf driver) designed for a traditional passive matrix liquid crystal display, such as a Twisted Nematic (TN) and supertwisted nematic (STN) displays, for example, to drive a bistable liquid crystal display.

### CROSS-REFERENCES TO RELATED APPLICATIONS

This application claims the benefit of provisional application Ser. No. 60/822,128, filed on Aug. 11, 2006, and provisional application Ser. No. 60/803,778, filed on Jun. 2, 2006, both incorporated herein by reference.

### BACKGROUND OF THE INVENTION

This application relates generally to an apparatus and method of driving an LCD. More specifically, this application relates to an apparatus and method of using a driver designed for a traditional passive matrix liquid crystal display, such as a Twisted Nematic (TN) and Supertwisted Nematic (STN) displays, for example, to drive a bistable liquid crystal display, allowing the use of an off-the-shelf driver device, for example.

In general, Bistable Liquid Crystal Displays (BLCD), and in particular, Cholesteric Liquid Crystal Displays (ChLCDs), have great potential to create low cost displays that are efficient power consumers. However, one of the major challenges of implementing such displays is the lack of a proper display driver/controller IC solution to achieve this goal.

Graphical passive matrix LCDs typically utilize a common architecture. The displays typically utilize a separate row driver, a column driver, a DC/DC power supply and a logic controller. This may be a logical approach for larger format displays, where the separate circuitry provides a modular design that can be scaled to various display sizes by cascading the appropriate number of row and column driver chips. Driving methods for graphical Cholesteric Liquid Crystal Displays (ChLCDs) can also follow this philosophy.

However, the ChLCD technology could have a cost advantage by utilizing existing off-the-shelf (OTS), large format (high voltage) STN row and column driver ICs. Drive methods for ChLCDs can evolve around the usage of these parts in order to maintain marketability of the displays. However, the compatibility between the STN drivers and the ChLCD technology is typically lost when considering STN drivers specifically developed for small format displays, due to lower drive voltages and the integration of the STN control algorithm. This is because the required drive voltage for STN displays is a function of the number of rows (multiplex ratio). As the number of rows is reduced, so is the drive voltage correspondingly reduced. However, this is not the case with the ChLCD technology, where voltage is independent of the number of rows of the display.

Low cost TN/STN LCD products typically use integrated display drivers. When the display voltage is low (e.g., 3V-5V), the IC integrates the row driver, column driver and controller. When the display voltage is higher than Vcc (logic supply voltage, e.g., 6V-15V), internal charge pumps can also be integrated into the IC to provide an increased voltage supply to drive the traditional display. That is, small format STN displays move to integrate the required blocks of circuitry (e.g.: row drivers, column drivers, DC/DC supply, and logic controller) into one IC. This enables a cost savings by minimizing the component count, for example.

ChLCD have not been able to use these integrated devices due to the low drive voltages and incompatibility of the embedded STN control algorithms. Without such an integrated solution, the ChLCD has previously been prevented from competing effectively in the small format display arena. Driving voltage for ChLCDs was typically at 30V, for example. This can be reduced to 15V with recent progress in advanced display material development and aggressive display process engineering. This could enable use of the integrated STN controller/driver ICs with internal power supplies.

Accordingly, with such advances in bistable displays, it would be useful to provide a method and a circuit for utililizing off-the-shelf STN display drivers to drive a bistable display, such as a ChLCD, and especially when such drivers are multi-component ICs as discussed above.

### SUMMARY OF THE INVENTION

Provided are a plurality of embodiments the invention, including, but not limited to, a device comprising a bistable display and a display driver adapted at manufacture for concurrently driving both rows and columns of a non-bistable passive matrix display connected for driving the bistable display.

Also provided is a device for driving a bistable display, with the device comprising: a driver adapted at manufacture for driving a non-bistable passive matrix display, the driver connected for driving the bistable display; a power supply for providing a voltage for driving the display; and a controller for generating a variable clock signal for providing to the driver. The variable clock signal includes a charge pump phase.

Still further provided is a device for driving a bistable display, with the device comprising: a driver adapted at manufacture for concurrently driving both rows and columns of a non-bistable passive matrix display, the driver connected for driving the bistable display; a power supply for providing a voltage for driving the display; and a controller for generating a variable clock signal for providing to the driver and also for generating at least one waveform coordinated with the clock signal for controlling one or both of an output of the power supply and an operation of the driver.

The variable clock signal of the above device includes a plurality of phases including: a row advance phase operating at a first frequency, a row drive phase operating at a second frequency, and a charge pump phase operating at a third frequency between the first frequency and the second frequency.

Further provided is device comprising: a bistable display; a driver adapted at manufacture for driving a non-bistable passive matrix display, the driver including an internal controller and an internal clock integrated in a common chip, the driver connected for driving the bistable display; and an external controller for controlling an external clock signal provided to the driver.

Additionally provided is a device comprising: a bistable display; a driver including a converter, the driver adapted at manufacture for driving a non-bistable passive matrix display, with the driver for driving the bistable display; an external converter for providing power to the driver; and a clock for providing a clock signal provided to the driver.

Provided also is a method of using an STN driver to instead drive a bistable display, the method comprising the steps of:
providing an STN display driver adapted at manufacture for concurrently driving both rows and columns of an STN display;
clocking the driver with a variable clock signal to produce an output; and
driving the bistable passive matrix display with the output.

Also provided are additional embodiments of the invention, some, but not all of which, are described hereinbelow in more detail.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a block diagram of a generic embodiment of the invention;

FIG. 2 shows a schematic of a modified S6B0724 STN driver/controller/power supply for providing a ChLCD operating mode using the IC internal power supply in a novel configuration;

FIG. 3 is a schematic showing the driver setup according to a first example embodiment of the invention;

FIG. 4 shows a schematic of a S6B0724 STN driver/controller/power supply for providing a ChLCD operating mode using an external power supply as a second example embodiment of the invention

FIG. 5 shows display drive waveform for the traditional STN.

FIGS. 6A-6C show example display drive waveforms of the first example embodiment for driving a ChLCD with internal voltage supply generation.

### DETAILED DESCRIPTION OF THE EXAMPLE EMBODIMENTS

Disclosed is a novel low cost implementation method and device for utilizing off-the-shelf STN driver/controller/power supply ICs to drive a bistable display, such as a ChLCD. This provides a method to enable small ChLCD to use these existing low cost driver ICs to enable cost-benefits in this small display market sector. The method/device provides specialized usage of traditional OTS hardware in such a way to enable the driving and control of ChLCDs through the use of a customized clock signal.

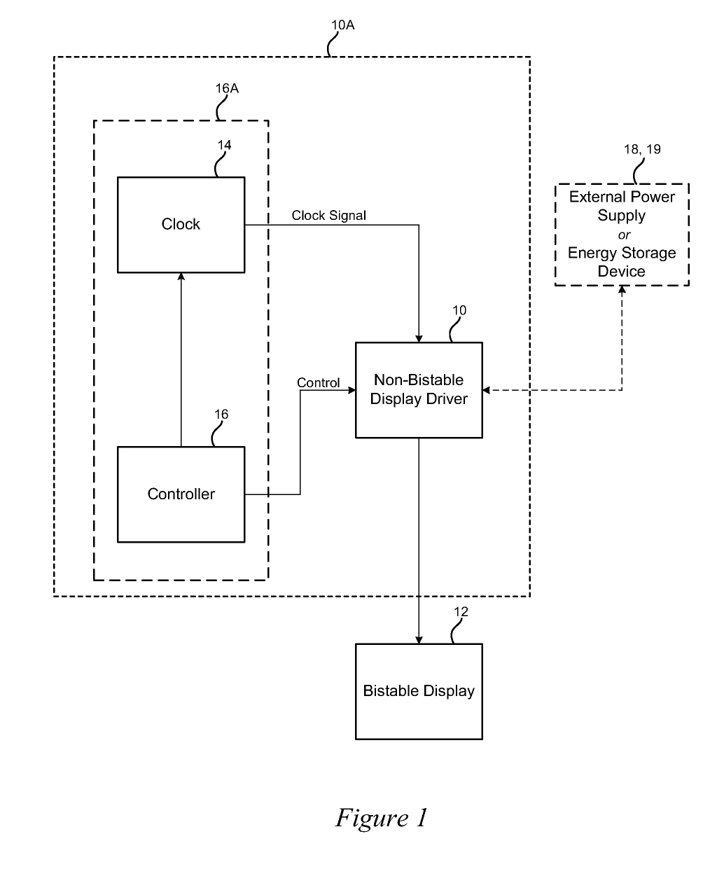

FIG. 1 shows a generic example embodiment of the invention. A commercially available display driver 10 manufactured for use in driving a non-bistable (e.g., traditional STN) display is provided with an external clock 14 and a controller 16 to drive a bistable display 12.

The driver 10 is powered by an external power supply 18. Alternatively, the driver 10 could be powered from an energy storage device 19. The energy storage device 19 might store energy provided by a low-power converter circuit, such as that disclosed in co-pending patent application “Power Management Method and Device for Low-Power Displays”, application Ser. No. 11/464,698, filed on Aug. 15, 2006 and incorporated herein by reference.

Note that an integrated controller chip 16A with an integrated clock 14 and controller 16 might be utilized. In that case, the customized clock signal can be created on a general purpose I/O pin of any common microcontroller. The customized clock signal is then fully programmable with software. Of course, an arrangement using a discrete clock 14 and controller 16 to control the clock could alternatively be used. Furthermore, an alternative commercially available driver device 10A might be utilized that has integrated both of the driver 10, and the integrated controller 16A, for example. Other combinations of these components are also possible for additional embodiments.

The arrangement of FIG. 1 generally shows that a commercially available driver 10 designed for use in with a non-bistable display can be modified to drive a bistable display 12, and thus the economies of scale of commercially available (and relatively cheap in bulk) driver devices can be utilized for driving bistable displays, such as ChLCDs. Accordingly, some embodiments of the invention utilize various commercially available integrated STN ICs in a unique way such as to allow compatibility with ChLCD technology or other bistable display technologies. This can help provide a low cost drive, voltage generation and control methodology.

Generally, the invention can provide a customized, variable clock signal to adapt a commercially available display driver 10 that is manufactured with the ability to drive a non-bistable display (often with some required external components added, as is typically shown in the manufacturer's data sheets) for instead driving a bistable display. Thus, the economies of scale, which tend to greatly reduce the costs of such display drivers 10 (or 10A), can be applied to bistable displays as well. For at least some commercial drivers, a clock signal having a variable frequency to support different phases of operation is utilized, as described in the examples discussed below using commercially available display driver IC chips.

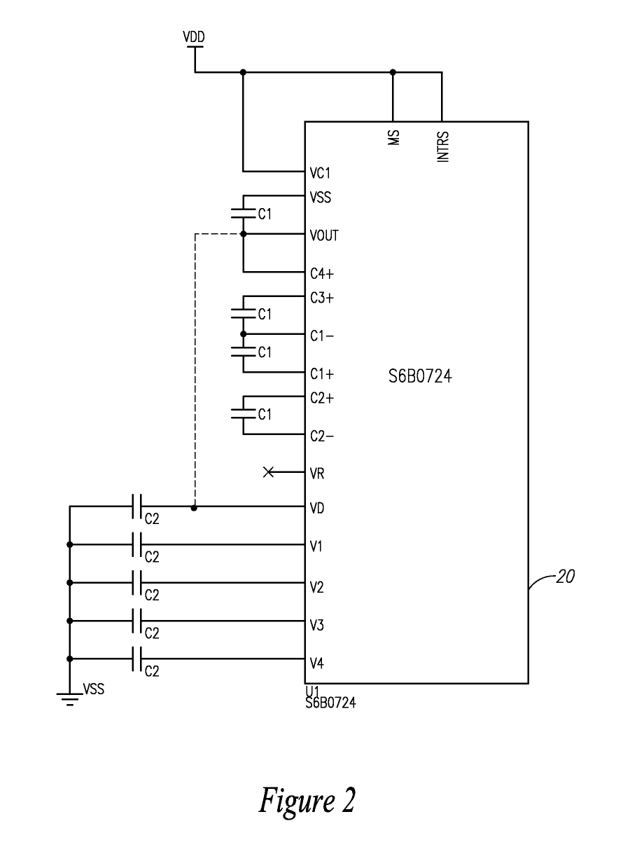

A specific first example of this type of STN driver/controller/power supply IC is the industry standard Samsung S6B0724 described as “132 Seg/65 Com driver and controller for STN LCD”. Many types and variations of this STN IC are available in the market from suppliers as such as Epson, Hitachi, Samsung, Novatek, Solomon and others. Such ICs typically have very similar architecture and function. One example embodiment discussed herein will focus on using the Samsung S6B0724 device 20, as shown in FIG. 2, for illustrative purposes; however it is appreciated that additional embodiments could implement such concepts using other STN/TN ICs instead.

This particular example IC was selected to provide high production volume and low cost. It is widely used in COG STN displays for monochrome cell phones, instrumentation, toys, and many other display applications. The Samsung S6B0724 device 20 has a built-in display controller with serial and parallel interface, 65 line row driver, 132 line column driver, and internal charge pump and related drive voltage generation circuitry. Being able to use such an IC with minimal external components can produce a lower cost product.

In order to utilize this type of STN chip, special innovative considerations must be made to operate the IC in a way that allows, for example, ChLCD operation. Although these families of STN ICs typically have integrated power supplies, it is also possible to use external power supplies when desired. Both configurations can be utilized with ChLCDs (or other bistable displays). Of course, it is desirable to utilize the internal supply whenever possible, but the desire to support larger display sizes and have greater freedom in generating drive waveforms without concern for the DC/DC conversion may suggest the use of an external power supply in at least some cases to supply the required drive voltage. A microcontroller can be utilized to enable and disable the chip's converter and follower using the command interface. Because the device operation techniques for each case are significantly different, this discussion can be logically divided into the subsequent two sections:

### Internal Power Supply Usage:

The internal DC/DC conversion circuitry of the example IC 20 can be enabled for ChLCD used for the example embodiment of FIG. 2. Because ChLCD can be made much more tolerant of voltage variations than STN displays, a novel configuration not supported by the device datasheet is possible. Specifically, as shown in FIG. 2, it is possible, using the S6B0724 device 20, to bypass the voltage regulator and feed the output of the voltage converter (VOUT) directly into the V0 input. The dotted line in FIG. 2 shows the additional connection not supported in the device datasheet. As in the datasheet, the circuit configuration is for a 4-time multiplier on the DC/DC conversion circuit, and the voltage converter and voltage follower are used. Differences from the datasheet is the external connection and that the voltage regulator is not used.

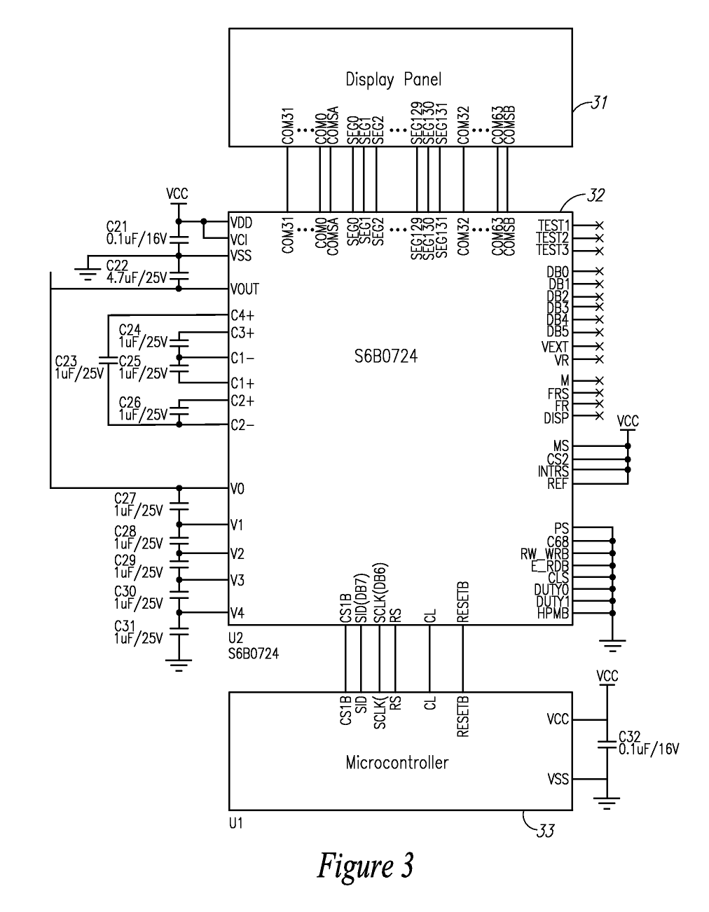

Although the above configuration is not required for driving a ChLCD, i.e the voltage regulator could be used, this configuration enables lower power operation of the display. The technique may also be applied to alternative IC configurations employing different DC/DC conversion ratios or capacitor arrangements for stabilizing V0 through V4. For example, an embodiment of the invention shown in detail in FIG. 3 applies the technique when using a 5-time multiplier on the DC/DC conversion circuit and a ladder arrangement for the V0 thru V4 stabilizing capacitors (C27 thru C31).

Typically, the provided DC/DC converter supplies a slightly noisy high voltage supply at VOUT. A voltage regulator circuit may be used to produce a clean voltage at a fixed, but lower, voltage value. However, ChLCDs are typically tolerant of driving with the noisy DC/DC converter voltage supply and don't typically need the clean regulated supply provided by a regulator. FIG. 2 illustrates how the regulator may be bypassed, if desired.

Typically, the internal DC/DC conversion power supply is controlled by the row clock. Because the STN display device continuously scans (clocks rows) at a high speed (e.g., greater than 60 frames per second), this method works well for that application. Each row clock triggers a charge pump cycle. However, for relatively slower ChLCD scanning, provisions should be made to enable the internal DC/DC conversion to be successful.

Specific non-traditional and novel control techniques as well as design concepts are provided utilizing the S6B0724 device example as follows:

FIG. 3 shows an example embodiment of the invention. The S6B0724 32 is configured for a 5-times DC/DC conversion ratio and the converter output (VOUT) is fed directly into V0. A display panel 31 is connected, which in this example case is a ChLCD. In general, the S6B0724 32 may drive a display panel with up to 65 commons and 132 segments. The display panel may connect to any subset of the segments and commons as dictated by the application. As configured in FIG. 3 (DUTY1 and DUTY0 equal VSS), the IC 32 will drive 33 commons. The device is configured for serial communications with the microcontroller 33 (PS equals VSS) and external clocking on CL (CLS equals VSS). The VCC power supply voltage may be adjusted to tune the drive voltage of the device. For example, a 3.0V VCC will give a 15V drive voltage with the 5-times DC/DC converter multiplier.

The microcontroller 33 transmits commands and data to the S6B0724 using the serial interface (CS1B, SID, SCLK, and RS), controls all clocking functions using the CL signal, and resets the device using the RESETB signal. All of these signals may be generated using the general purpose I/O of any common microcontroller.

OPERATING MODE: Unlike the typical STN device operation which continuously scans, the ChLCD operation will perform a finite number of device scans. That is, the display controller will be operated only during an update period. The device should be turned off between updates so that there will be no power used or disruption of the stable image.

VARIABLE CLOCK FREQUENCY: This example display driver is designed with a pre-selected multiplexing ratio such as, for example, 1/33, 1/49, 1/55, 1/65. That is, STN drivers have a constant scan rate that is a function of the level of multiplexing (i.e., number of rows). This is because STN displays require constant refresh in order to maintain images. The internal oscillator of the S6B0724 clocks from one row to the next at a typical frequency of 2.907 kHz when configured for a 1/33 duty ratio, for example.

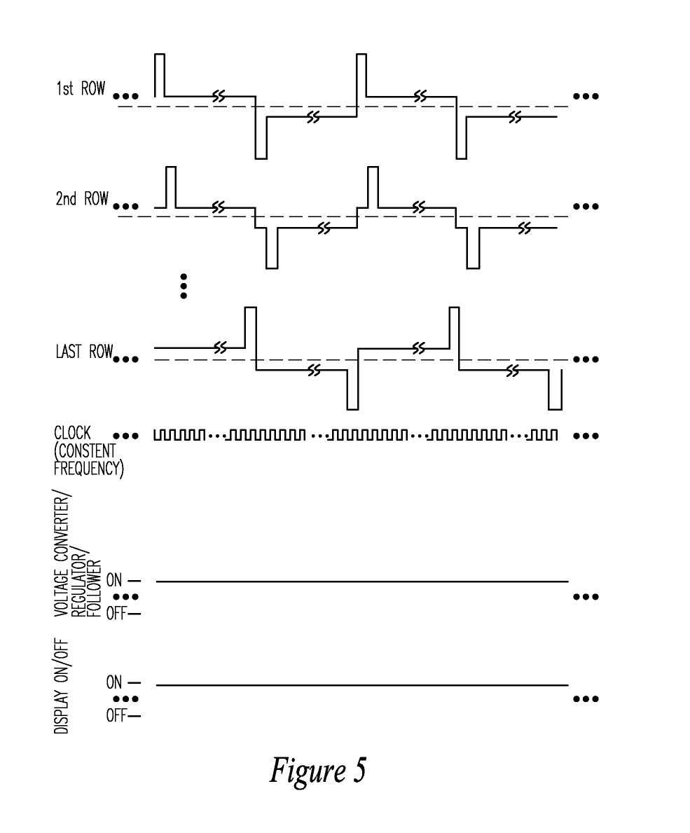

FIG. 5 shows representative voltage waveforms across any pixel in multiple rows for typical STN scanning and the special case of all bright image data. The inclusion of dark image data would only affect the waveforms by reducing the magnitude of the select voltage across a pixel (from V0 to V2) and changing the polarity of the nonselect voltage across all other pixels on the same segment. Each row is selected in turn, with pixels in the selected row seeing a high voltage signal (±V0 for bright pixels and ±V2 for dark ones) that sets the image content of the row. Pixels in the remaining 32 nonselect rows see a low voltage signal (±V1), whose magnitude is so low as to not affect the image content on those rows. Note that for STN operation, the clock signal uses a fixed frequency; the voltage converter, regulator, and follower are always enabled; and the display on command is issued such that one row is always being driven.

The STN scan rate is typically too fast for ChLCD driving. Current ChLCDs driving at the low voltage levels (˜15V) provided by drivers such as the S6B0724 require a typical row select time of at least on the order of about 15 ms (66.7 Hz clock rate) at room temperatures. The DC/DC conversion circuitry is unable to maintain the drive voltages using the standard STN waveforms at such low clock frequencies. As such, several novel techniques are herein discussed to drive the display with the necessary row select times as well as manipulate the DC/DC conversion in order to provide the necessary drive voltages.

For ChLCD driving, there is no requirement for a constant scan (clock) rate because the bi-stability of the ChLCD eliminates the need for regular display refresh. Additionally, it is possible to provide an external clock signal (CL) from a microcontroller to the driver. The frequency of the external clock signal need not be constant, but instead can be varied in order to achieve the goals of providing the required minimum row select time for driving a ChLCD and managing the DC/DC converter to provide the drive voltages. This can be accomplished in software as the clock signal is created on a general purpose I/O pin of the microcontroller. Many types of update waveforms are made possible by using the variable clock frequency techniques outlined in the following discussion.

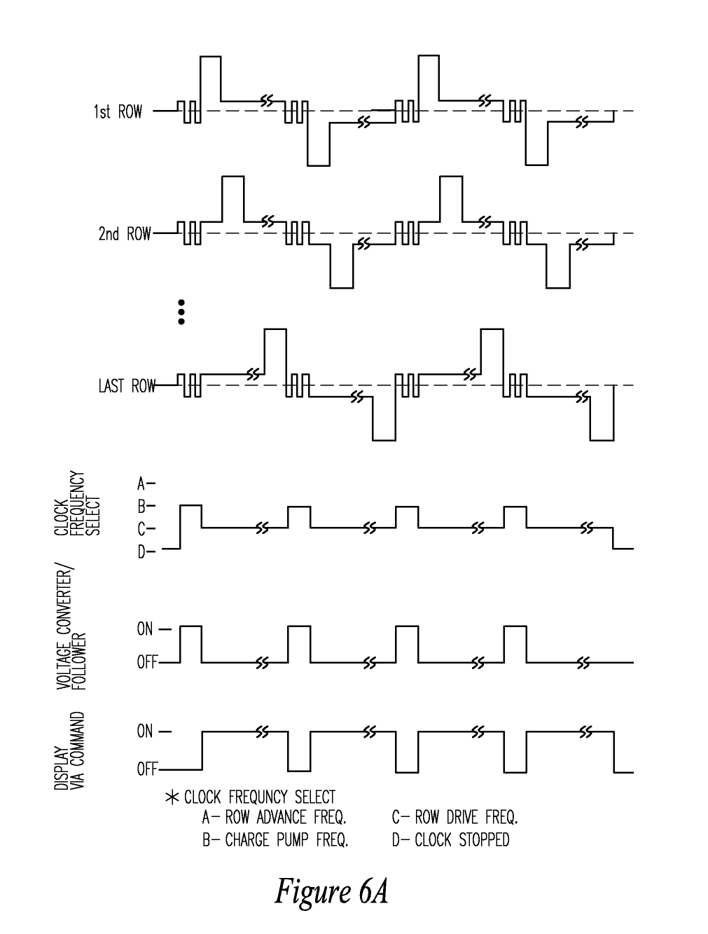

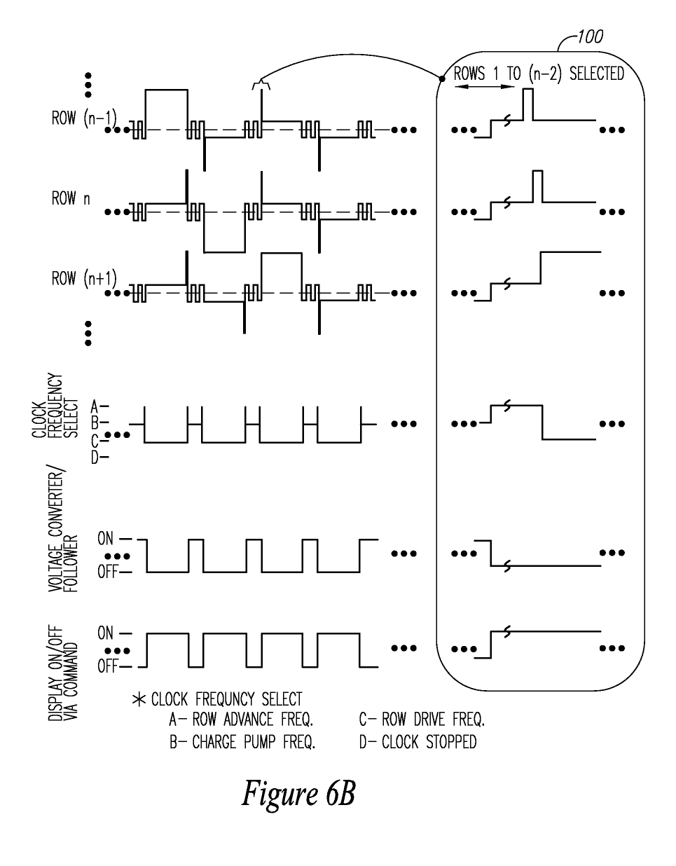

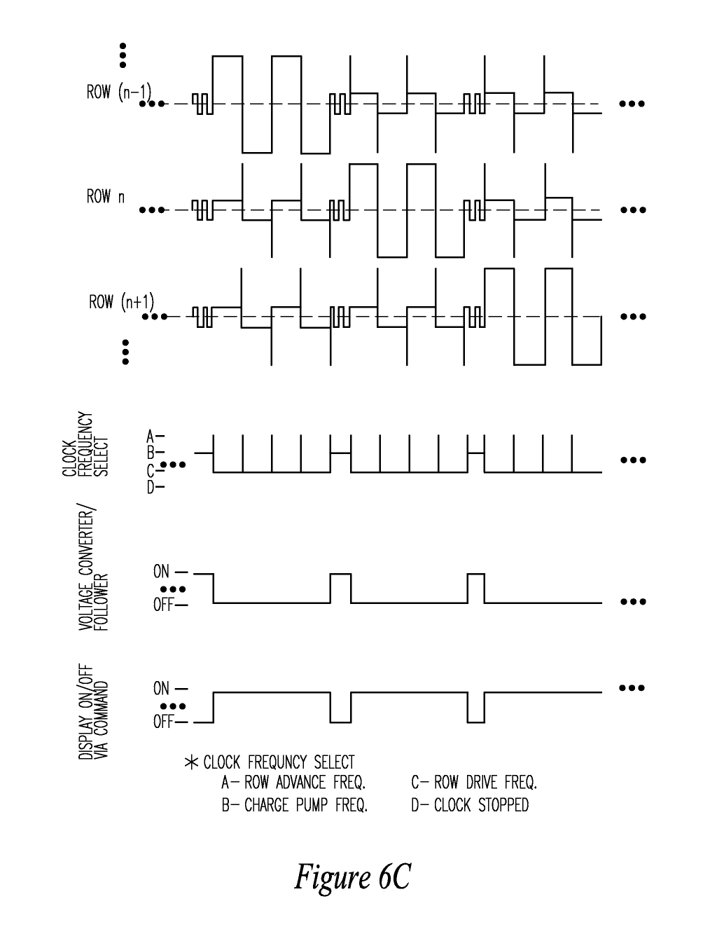

Variable frequencies include, but are not limited to, one frequency optimized for replenishing the capacitors with the charge pump, one frequency for advancing the row pointer without driving image content to the select row, and one frequency for driving image data to the select row. FIG. 5 shows a fixed frequency because frequency is constant for STN functionality. FIGS. 6A-6C illustrate the use of these 3 clock frequencies at various points during a display update. Thus, the clock can be provided in “phases” with each phase at a different frequency, for example, for support of a particular function. The phases then would typically be repeated in updating the display. Such repeating may be regular, or based on an event (such as an image change requiring a display update).

VARIABLE CLOCK FREQUENCY (I)—ROW ADVANCE PHASE: As shown in FIG. 5, when the display is enabled (on), one common of the S6B0724 is always selected and the pixels associated with that common (display row) receive the high voltage drive signals ±V0 or ±V2. The select row is advanced to the next common (row) in sequence by a pulse on the externally provided clock signal CL (or the internal clock signal if so configured). However, greater freedom is achieved in designing drive waveforms and managing the DC/DC converter if the external clock may be used to arbitrarily set the select row.

Any row may be selected by giving the clock signal CL the appropriate number of pulses to advance from the current select row to the desired select row. However, all of the rows in between will be selected in turn and thus see the select drive voltages. It is generally desired that the image content on these in-between rows not be disturbed. This is accomplished by giving the ‘row advance’ clock pulses at such a high frequency that the select voltage pulses seen on rows between the current and desired select row are so short that they leave the image content on those rows unaffected (or at least minimally affected). In the example embodiment of FIG. 3, these clocks are given in about the 1 MHz range.

VARIABLE CLOCK FREQUENCY (II)—ROW DRIVE PHASE: As shown in FIG. 5, the select row receives the high voltage drive signals. For ChLCD operation, when it is time to drive a given row, the appropriate common may first be selected using the ‘row advance’ clock pulses described above. The external clock signal CL may then be slowed down for one cycle (i.e., provided at a lower frequency) to give the desired drive pulse width on the select row. This may be called a ‘row drive’ clock pulse, because the frequency of this pulse determines the time that the row drives with the select voltages. In the example system of FIG. 3, these clocks would generally be in the 1 to 1000 Hz range at room temperatures.

VARIABLE CLOCK FREQUENCY (III)—CHARGE PUMP PHASE: The ChLCD scan rate is typically too slow for the DC/DC converter to maintain the necessary drive voltages with a single clock cycle per row. Therefore, an approach can be used where the drive voltages are supplied by capacitors, which may be recharged by the DC/DC converter (and/or voltage follower) at select points during a display update. A third clock frequency is useful in order to efficiently operate the charge pump. The “charge pump” clock frequency should be slower than the “row advance” clock frequency, for example, no greater than about 7.5 kHz, to operate. The “row advance” frequency should generally not be slowed down to this rate because the select pulses seen on the rows being clocked over to position the row pointer would be of sufficient duration to begin affecting the image. It is generally desirable to charge the driving voltage supply as quickly as possible, making the “row drive” frequency undesirable to use for the charge pump.

Additional considerations should be considered in order to optimize the DC/DC conversion. The following outlines four techniques for optimizing its performance:

DC/DC OPTIMIZATION (I)—DISABLE OUTPUTS: If possible, the driver outputs should be disabled while performing charge pump clock cycles. The system will operate most efficiently if charge is not spent driving the display panel during this time. Unfortunately, this approach has not been found possible with the S6B0724.

DC/DC OPTIMIZATION (II)—DISPLAY OFF: Drivers such as the S6B0724 have a “display off” command which causes the driver to drive nonselect voltage levels to the select row as well as the nonselect rows. In addition, the nonselect voltage level is constant (no polarity change) during a scan such that a minimum of energy is expended in driving display pixels between different polarities of the nonselect voltage. This expense occurs only once at the start of each scan when the nonselect voltage polarity changes. Thus, the DC/DC conversion can operate rather well in this “display off” mode. Additionally, as no select voltages are applied to the display, the “charge pump” clock frequency may be optimized without regard to the affect of a select pulse on the image content.

DC/DC OPTIMIZATION (III)—UNCONNECTED ROWS: A third approach is to use unconnected rows (commons not physically connected to a display panel) for “charge pump” clock cycles. In this case, the display remains enabled but the select pulse for charge pump cycles is seen only on unconnected rows, which have no image on an actual display panel to corrupt. “Row advance” clock cycles are used to advance past connected rows without disturbing the image content. Once the voltage levels have recovered and the appropriate row is in the select position a “row drive” clock cycle may be used to once again drive a connected row. In this case it is advantageous, although not necessarily required, for the unconnected rows to be filled with bright pixel data, such that the nonselect voltages seen by pixels in the connected rows will be constant and in-phase with the select voltages over a given scan.

DC/DC OPTIMIZATION (IV)—DATA MANIPULATION: A fourth approach is to manipulate the display image content before executing “charge pump” clock cycles. Image data is changed before rows receive “charge pump” clock cycles such that they contain fixed, preferably dark, pixel data. By using fixed data in all the rows, the nonselect voltage on the display does not change polarity during a scan and a minimum of energy is expended switching the display. Dark data is preferred because the select row receiving the “charge pump” clock cycle will see a drive pulse. The impact of this pulse on the image content is minimized by using the dark (±V2) voltage level rather then the higher bright (±V0) level.

Using one or more of the above techniques enable the implementation of traditional ChLCD drive waveforms and drive methods including DC balancing, selective update, and cumulative drive with the selected display format.

CONTROL OF VOLTAGE CONVERTER CIRCUIT: The voltage converter includes a charge pump that operates off of the row clock. The voltage converter typically performs best at the “charge pump” clock frequency. As such, it can be enabled to generate the high voltage level at the “charge pump” clock frequency and disabled when generating the update portions of the output waveforms using the “row advance” and “row drive” clock rates.

CONTROL OF VOLTAGE FOLLOWER CIRCUIT: The internal voltage follower circuit is comprised of a group of op-amps, and can be used to set up the proper display driving voltage levels. These voltage levels are buffered by external capacitors connected to the IC. However, during the long drive pulse, when the charge pump doesn't function (no clock), the voltage follower unnecessarily consumes a significant amount of energy. Therefore, for this example embodiment, the follower is turned “on” during the “charge pump” clock cycles which replenish the drive voltages on the capacitors, in order to establish the proper voltage levels. The follower is turned “off” at all other times, such as while driving the selected row with a “row drive” clock pulse or choosing the select row with “row advance” clock pulses. As discussed in co-pending patent application “Power Management Method and Device for Low-Power Displays”, application Ser. No. 11/464,698, filed on Aug. 15, 2006 and incorporated herein by reference, disclosing a method to minimize power consumption for a low power display, the DC/DC conversion circuitry (i.e. converter, regulator, follower) can be turned on and off in a controlled manner, with at least part of the energy for the update being stored in capacitors charged by the converter during a short active period. This conserves energy (by inactivating the converter during a substantial portion of the display update period) and also permits the supply to recover in a shorter amount of time. ChLCD are much more tolerant to the voltage variations which result from disabling the voltage follower than typical STN displays, which would typically have the follower enabled.

FIGS. 6A-6C illustrate a few examples of the numerous possible waveforms which may be generated to drive a ChLCD with internal voltage supply generation using some of the above techniques. For simplicity, these figures assume all planar image data such that the polarity of the nonselect voltages does not vary with the image data in the select row.

The drive capacitors (e.g., C27 to C31 in FIG. 3) are all charged in a similar manner in the examples of FIG. 6A-6C. First, the select row is advanced to the end of a scan. “Row advance” clock pulses may be used for this if necessary or desired. Next, the “display off” command is used to disable driving the select voltages to the select row. The voltage converter and follower are enabled via the command interface, and an external clock is provided to CL at the “charge pump” frequency used to optimize the DC/DC conversion. Enough “charge pump” clocks are applied to refresh the drive voltages on the capacitors to the required levels and return the select row pointer to the end of a scan of desired AC phase (phase automatically toggles every scan). Finally, the voltage converter and follower are disabled via the command interface, the display on command is sent to enable the select voltages to the select row, and the necessary number of clock pulses (typically at the “row advance” rate) are used to choose the select row.

FIG. 6A illustrates a drive waveform for ChLCD which appears most similar to the standard STN drive waveform of FIG. 5. In FIG. 6A, the DC/DC converter and follower are run only between full image scans, with the drive voltages during the scans provided from the charge stored in the capacitors connected to V0 through V4. The “row drive” frequency is used to drive each row in turn for a single display scan. The only apparent difference in the drive waveforms from the STN case is the small time period of AC nonselect voltages between the scans. This process, DC/DC conversion to charge drive capacitors followed by a display scan, can be repeated as many times as necessary to cumulatively transform the previous image into the new image. After the final scan, the driver outputs are completely disabled. Typically, a minimum of two to four such scans are necessary. Using an even number of scans provides for a dc-balanced waveform.

This example uses two clock frequencies, “charge pump” and “row drive”, as compared to the typical single frequency used to drive STN displays. Note that in order to limit this example to two frequencies, the top row of the display is selected using clock pulses at the “charge pump” frequency, rather than the more typical “row advance” frequency. This is possible because there are no connected rows on the display that become selected when advancing to select the top row after replenishing the drive capacitors with the DC/DC converter. Of course, the “row advance” frequency could also be used for this purpose.

FIG. 6B illustrates a drive waveform for ChLCD in which the drive voltages stored in the capacitors is replenished before driving each row, using the procedure described above. In this approach, a single clock pulse at the “row drive” frequency is used between each capacitor charge cycle. Rows following the drive row each see a short voltage spike in sequence as the row pointer is advanced to the end of the frame by the row advance clock ticks. For example, the row n and row (n+1) voltage waveforms have spikes immediately following the long drive pulse on row (n−1). Likewise, each row preceding the drive row sees a short voltage spike in sequence as the row pointer advances to the drive row. For example, the row (n−1) and row n voltage waveforms have spikes immediately preceding the row (n+1) drive pulse. See the callout portion 100 of the timeline for more detail about this timing, as shown in FIG. 6B. As described, these pulses are of short enough duration as to not disturb the image content on these rows. The waveforms in FIG. 6B clearly may be extended such that each row is driven once per scan over multiple scans until the final image is developed.

FIG. 6C illustrates a drive waveform in which the select row is driven with an AC waveform. In this case, the drive row is first selected as usual using “row advance” clock pulses. Next, the select pulse is applied by giving one clock cycle at a “row drive” frequency. In the case of a 1/33 multiplex ratio, 32 row advance clock cycles are used to advance the row pointer back to the same row while inverting the polarity of the drive voltage. The process of a single “row drive” clock pulse followed by 32 “row advance” clock pulses may be repeated as many times as necessary to achieve a total drive pulse of required duration, frequency, and dc balance. The waveform will have a short duration of nonselect between polarity changes, but the duration may be made small enough such that the liquid crystal does not respond to it and behaves as if the select voltage had been continuously applied. Replenishment of the capacitor voltages is as before. The waveforms of FIG. 6C clearly may be extended such that each row is driven once per scan over multiple scans until the final image is developed.

Although the previous discussion focuses on updating the display using multiple scans (meaning a visible scan line travels over the display multiple times), it is also possible to create updates in a single scan. One approach to update in this manner is to apply the select voltages to a single row multiple times (typically four or more) separated by a few milliseconds (at room temperature) of nonselect voltages. The short nonselect periods may be created by using “row advance” clock pulses to briefly select and pause on an unconnected row. Alternatively, a DC/DC conversion cycle may be entered to replenish the drive capacitors during this time. The nonselect periods should be of small enough duration that the liquid crystal does not have time to visibly relax, but of long enough duration that the turbulence created in the liquid crystal is enough to eliminate ghosting of the previous image. If not possible during the nonselect periods within a row, DC/DC conversion may be performed between each row.

### Use of an External Power Supply

A major challenge in using the existing internal power supply is that the row clock controls both the internal power supply switching and the drive timing. The two primary benefits of using the internal supply are significant reduction in the overall cost and optimization of the design size. For many applications these two benefits may be very important.

However, for certain applications, an external power supply can be used, as shown in this additional example embodiment. The use of an external power supply uncouples the relationship between voltage supply generation and row clocking. This can improve the display performance, permitting a larger size, higher resolution, and increased update rate. An external power supply can be implemented with various combinations of available integrated circuitry such as the internal voltage follower and internal voltage regulator. Alternatively (or in addition), an external regulator/follower can be used.

An external supply can be combined with the variable clock frequency drive method. Greater freedom in waveform design is then permitted due to the decoupling of the voltage generation and the row clocking frequency. For example, with an external supply the portions of the update waveforms in FIGS. 6A-C which don't affect the image, but are dedicated to replenishing the drive voltage capacitors, may be eliminated. This can lead to an increased display update rate. Additionally, AC drive waveforms, such as in FIG. 6C, may be simpler to implement (in circuit design and/or control) using an external supply. The continuous supply of drive voltages provided by the external supply provides the energy for driving at higher frequencies and for longer durations, without concern for maintaining the charge on the drive voltage capacitors.

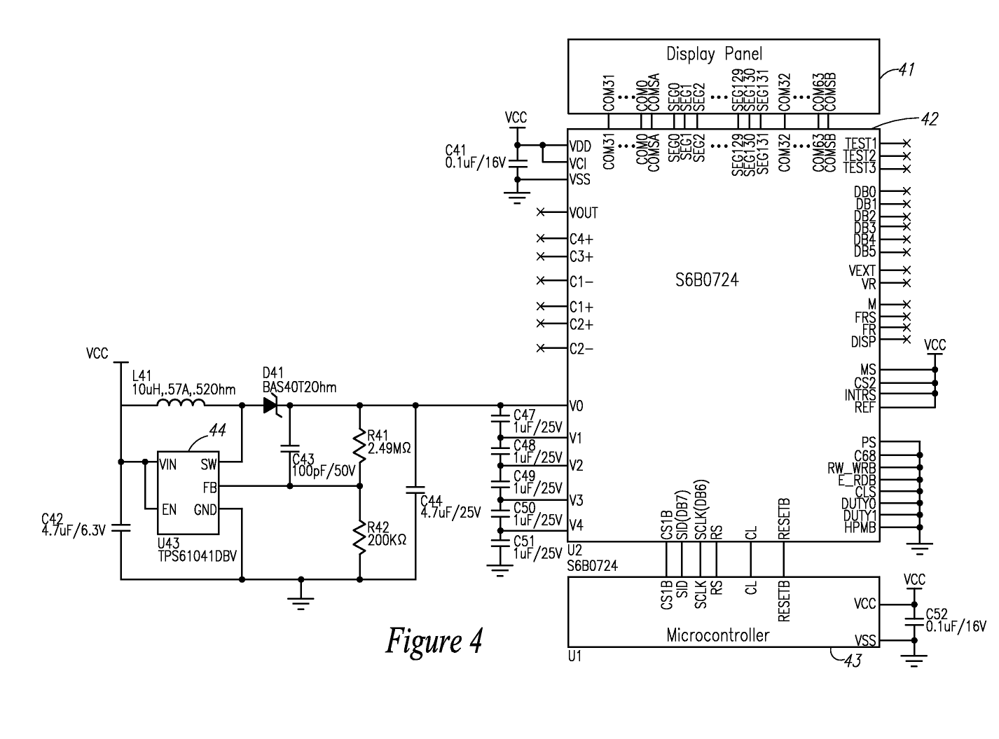

FIG. 4 shows an implementation of a second example embodiment. This embodiment is comprised of a microcontroller 43, display panel 41, Samsung S6B0724 driver/controller 42, and an external power supply 44 with appropriate support circuitry. The microcontroller 43 to S6B0724 42 connections and S6B0724 42 to display panel 41 connections are the same as for the internal supply. The primary difference is that an external DC/DC conversion circuit based around the Texas Instruments' TPS61041, described as “Low Power DC/DC Boost Converter in SOT-23 Package” has been added, and the capacitors used to support the S6B0724 internal charge pump have been eliminated. The TPS61041 uses inductor L41 to build up charge (voltage) on capacitor C44. Resistors R41 and R42 provide feedback such that the voltage level on C44 can be set to the desired level. The S6B0724 is configured through the command interface for drive voltage V0 to be supplied externally. Additionally, the S6B0724 internal voltage follower may be enabled to establish the correct voltage levels on V1 to V4.

CONTROL OF EXTERNAL SUPPLY: ChLCDs can be made quite tolerant of voltage variations. In another innovation, described in co-pending patent application “Power Management Method and Device for Low-Power Displays”, application Ser. No. 11/464,698, filed on Aug. 15, 2006 and incorporated herein by reference, in order to minimize the power consumption, the DC/DC conversion circuitry can be turned on and off in a controlled manner. For example, the high voltage supply could be enabled and disabled at select times by the addition of a control line from a microcontroller general purpose I/O pin to the enable (EN) pin of the TPS61041. Additionally, the command interface to the S6B0724 may be used to enable and disable the voltage follower. These components may be enabled and disabled at various times during an update in order to save energy, with the energy for the update being supplied by the charge on the drive voltage capacitors. This is possible since the ChLCD is more tolerant of unregulated voltages than the original STN target.

Of course, additional embodiments utilizing other STN display driver ICs, along with similar modifications as those disclosed herein, can also be utilized to practice the invention.

The invention has been described hereinabove using specific examples and embodiments; however, it will be understood by those skilled in the art that various alternatives may be used and equivalents may be substituted for elements and/or steps described herein, without deviating from the scope of the invention. Modifications may be necessary to adapt the invention to a particular situation or to particular needs without departing from the scope of the invention. It is intended that the invention not be limited to the particular implementations and embodiments described herein, but that the claims be given their broadest interpretation to cover all embodiments, literal or equivalent, disclosed or not, covered thereby.

What is claimed is:

1. A device comprising:
a bistable display; and
a display driver, adapted at manufacture for concurrently driving both rows and columns of a non-bistable passive matrix display, connected for driving said bistable display.

2. The device of claim 1, further comprising:
a clock circuit; and
a controller for controlling said clock circuit for driving said driver with a variable clock signal.

3. The device of claim 2, wherein said variable clock signal is an intermittent clock signal.

4. The device of claim 2, wherein said variable clock signal is a clock signal having a variable frequency.

5. The device of claim 4, wherein said variable clock signal is also an intermittent clock signal having at least three different frequencies.

6. The device of claim 4, further comprising a DC/DC converter circuit for providing a voltage used for driving said bistable display.

7. The device of claim 6, wherein said DC/DC converter is integrated within said driver.

8. The device of claim 7, wherein said variable clock signal includes two or more of:
a row advance phase for selecting a desired select row by providing an appropriate number of pulses at a first frequency to advance from a current select row to a desired select row;
a row drive phase for providing a desired drive pulse width on the current select row at a second frequency; and
a charge pump phase at a third frequency set between said first frequency and said second frequency for operating a charge pump of said converter circuit.

9. The device of claim 8, wherein said first frequency is substantially greater said second frequency.

10. The device of claim 8, wherein at least some of the driver outputs of said driver are disabled during said charge pump phase.

11. The device of claim 8, wherein a “display off” command is executed during said charge pump phase.

12. The device of claim 8, wherein unused row outputs of the driving device are selected when providing charge pump clock cycles.

13. The device of claim 8, wherein display data is manipulated to contain fixed and dark pixel data before executing said charge pump clock cycles.

14. The device of claim 8, wherein said DC/DC converter circuit is disabled during said row advance and said row drive phases.

15. The device of claim 7, wherein said variable clock signal includes:
a row advance phase for selecting a desired select row by providing an appropriate number of pulses at a first frequency to advance from a current select row to the desired select row;
a row drive phase for providing a desired drive pulse width on the current select row at a second frequency; and
a charge pump phase at a third frequency set between said first frequency and said second frequency for operating a charge pump of said converter circuit.

16. The device of claim 6, wherein said DC/DC converter is part of an external power supply separate from said driver, and wherein said external power supply is connected to said driver and drives said bistable display through said driver.

17. The device of claim 6, wherein said controller includes said clock circuit for providing said variable clock signal.

18. The device of claim 2, wherein said controller includes said clock circuit for providing said variable clock signal.

19. The device of claim 2, wherein a voltage follower circuit of the standard driver is turned off by said controller before driving a row of said bistable display at a long pulse, and wherein said voltage follower circuit is turned on by said controller after driving the long pulse and during the driving of a voltage recovery time.

20. The device of claim 1, wherein said bistable display is a cholesteric liquid crystal display (ChLCD).

21. A device for driving a bistable display, said device comprising:
a driver adapted at manufacture for driving a non-bistable passive matrix display, said driver connected for driving the bistable display;
a power supply for providing a voltage for driving the bistable display; and
a controller for generating a variable clock signal for providing to said driver, wherein
said variable clock signal includes a charge pump phase.

22. The device of claim 21, wherein said variable clock signal also includes one or both of a row advance phase and a row drive phase.

23. The device of claim 21, wherein said variable clock signal includes both a row advance phase and a row drive phase with said row advance phase being a different frequency than said row drive phase.

24. The device of claim 21, wherein said controller is also for generating at least one waveform different from said clock signal for controlling one or both of an output of said power supply and an operation of said driver.

25. The device of claim 21, wherein said power supply includes a DC/DC converter, and wherein said power supply is included in said driver in a single chip.

26. A device for driving a bistable display, said device comprising:
a driver adapted at manufacture for concurrently driving both rows and columns of a non-bistable passive matrix display, said driver connected for driving the bistable display;
a power supply for providing a voltage for driving the bistable display; and
a controller for generating a variable clock signal for providing to said driver and also for generating at least one waveform coordinated with said clock signal for controlling one or both of an output of said power supply and an operation of said driver, wherein
said variable clock signal comprises a plurality of phases including: a row advance phase operating at a first frequency, a row drive phase operating at a second frequency, and a charge pump phase operating at a third frequency between said first frequency and said second frequency.

27. The device of claim 26, wherein said driver is an S6B0724 driver which includes said power supply integrated therein.

28. A device comprising:
a bistable display;
a driver adapted at manufacture for driving a non-bistable passive matrix display, said driver including an internal controller and an internal clock integrated in a common chip, said driver connected for driving said bistable display; and
an external controller for controlling an external clock signal provided to said driver.

29. The device of claim 28, wherein said clock signal is a variable frequency clock signal.

30. A device comprising:
a bistable display;
a driver including a converter, said driver adapted at manufacture for driving a non-bistable passive matrix display, said driver for driving said bistable display;
an external converter for providing power to said driver; and
a clock for providing a clock signal provided to said driver.

31. The device of claim 30, wherein said clock signal is a fixed frequency substantially below the frequency for driving an STN display for which the driver was manufactured.

32. A method of using an STN driver to drive a bistable display, said method comprising the steps of:
providing an STN display driver adapted at manufacture for concurrently driving both rows and columns of an STN display;
clocking the driver with a variable clock signal to produce an output; and
driving the bistable passive matrix display with said output.
